(19) United States
(12) Patent Application Publication
(10) Pub. No.: US 2011/0009268 A1
(43) Pub. Date: Jan. 13, 2011

(54) IPBC-CONTAINING COACERVATES

(76) Inventors: Hermann Uhr, Leverkusen (DE); Daniel Rudhardt, Koln (DE); Frank Ridder, Kurten (DE); Johan Kijstra, Odenthal (DE); Sascha Plug, Leverkusen (DE)

Correspondence Address: LANXESS CORPORATION, 111 RIDC PARK WEST DRIVE, PITTSBURGH, PA, 15275-1112, US

(21) Appl. No.: 12/223,039

(22) PCT Filed: Jan. 23, 2008
(86) PCT No.: PCT/EP2007/000521

§ 371 Date: Oct. 1, 2010

(30) Foreign Application Priority Data
Feb. 1, 2006 (DE) 10 2006 004 526.2

(51) Int. Cl. A01N 47/12; A01N 25/00; A01N 47/10; A01P 3/00; A01P 1/00; A01P 7/00; A01N 43/68; A01P 13/00

(52) U.S. Cl. 504/143; 424/405; 514/478; 514/479; 514/245

(57) ABSTRACT

The novel process for coacervating iodopropargyl compounds affords stable aqueous dispersions of coacervated iodopropargyl compounds which, optionally in a mixture with further active biocidal ingredients, can be used very effectively to protect technical materials.

The invention relates to a process for coacervating iodopropargyl compounds, to stable aqueous dispersions of coacervated iodopropargyl compounds and their use for protecting industrial materials, to mixtures with further biocidal actives, to processes for preparing these mixtures, and to fungicidal compositions based on coacervated iodopropargyl compounds.

Iodopropargyl compounds are known actives which are used in particular in the protection of materials for the purpose of protecting industrial materials such as adhesives, glues, paper and card, textiles, leather, wood, woodbase materials, coating materials and plastic articles, cooling lubricants, and other materials that may be infested or decomposed by microorganisms, from infestation, particularly by fungi. The best-known representative is IPBC (iodopropargyl butylcarbamate). IPBC is available commercially, either in solid form, or else in various liquid concentrates, the majority of which, however, contain organic solvents. The demand for formulations which contain no VOC (volatile organic compound) or only a small, small amount of VOC has, however, risen sharply in recent years. Appropriate formulations here are aqueous suspensions. Aqueous IPBC suspensions available in commerce to date, however, have a poor storage stability, since, as a result of crystallization, there is soon a sharp rise in the viscosity, in conjunction with significantly impaired processing properties. The reason for this is the poor solubility of the active in water; in aqueous systems, this results in large particles growing at the expense of small particles. In the course of storage, particularly at relatively high temperatures, this leads to the formation of large crystals, in conjunction with—in some cases massive—sedimentation or increase in viscosity. This process is referred to as “Ostwald ripening” and is described extensively in the literature (see Formuliertechnik, H. Mollet and A. Grubemann, Wiley-VCH, Weinheim 2000, pp. 320-322).

Furthermore, it is difficult to prepare formulations which contain other actives as well as IPBC. Particularly in the case of the preparation of suspoemulsions, there are frequent instances of strongly pronounced heteroflocculation, leading to agglomeration and hence to a severe reduction in the stability of the formulation.

It has now been found that the crystallization (Ostwald ripening) in aqueous iodopropargyl-containing formulations and preparations can be significantly retarded, and the compatibility of iodopropargyl compounds with other actives significantly enhanced, by surrounding the iodopropargyl compounds with a coacervate shell, which where appropriate may also be crosslinked. It has further been found that the biological activity in the application forms is unaffected by such formulation.

Coacervation as a term is known in the technical literature and refers generally to the precipitation of a hydrophilic colloid materials onto solid materials, solutions or melts.

Aqueous dispersions have already been disclosed that comprise iodopropargyl compounds and, as a formulating aid, partially hydrolyzed polyvinyl alcohol, and whose use is intended to reduce crystal growth in formulations (cf. WO 00/57702).

The method of coacervation is widely described in the literature and has been employed widely, to actives as well, for the purpose of producing slow release formulations. Preventing Ostwald ripening, particularly in the case of iodopropargyl compounds, is not described. Likewise not described is the use of coacervates for preventing heteroflocculation in formulations.

One way that is frequently utilized of encapsulating liquid or solid actives in suspension and/or emulsion is that of simple or complex coacervation. The underlying physical and chemical processes attending these two encapsulation methods are well understood and described extensively in the literature. In the patent literature not only the method of complex coacervation (cf., e.g. GB-A 1475229 and U.S. Pat. No. 2,800,458) but also that of simple coacervation (cf., e.g., GB-A 1275712) have been described.

The fundamental principle attending this microencapsulation method is the phase separation of one or more dissolved polymers from an original aqueous solution and the accretion of the resulting coacervates at the interface of suspended or emulsified particles.

In the case of simple coacervation, the phase separation is induced in an aqueous solution of a polymer. This can be realized in principle with any aqueous polymer solution, by selecting the correct condition of pH, solvent, or salt concentration. Typical examples are gelatin/water/ethanol or gelatin/water/sodium sulfate solutions in which the formation of coacervates is controlled by alteration of the salt concentration or by changing of the amount of organic solvent.

Complex coacervation can be realized with two or more dissolved polyelectrolytes with different net charges by appropriately selecting the pH or the salt concentration of the system. By this means it is then possible for polyelectrolytes with different charges to be attracted to one another and to undergo joint precipitation in the form of a complex. One typical combination, and the most thoroughly investigated system of polyelectrolytes, is gelatin and gum arabic.

Coacervate shells can be chemically crosslinked subsequently, giving them a high mechanical stability. Gelatin/gum arabic coacervates, for example, can be crosslinked with glutaraldehyde or formaldehyde or by complexation with metal cations.

The present invention provides a process for coacervating iodopropargyl compounds that is characterized in that
a) an aqueous solution of one or more hydrophilic colloids is mixed with at least one iodopropargyl compound and
b) by adding coacervating aids or by changing the ambient conditions, the hydrophilic colloids are precipitated or deposited on the particle surface of the iodopropargyl compounds, and
c) if desired, the coacervate shell of the iodopropargyl compounds thus prepared is crosslinked.

The hydrophilic colloids are preferably polymers which are ionizable and may be present in mixtures with one another having different electrical charges, and which, accordingly, have amphoteric properties. Suitable colloids are not only those which lead to simple coacervation but also those which lead to complex coacervation. Hydrophilic colloids suitable for performing the process of the invention are, more particularly, gelatin, agar-agar, albumin, cellulose derivatives, carraghenan, chitosan, soy protein, polyvinyl alcohol, gliadin, starch, or, in the case of complex coacervation, the combinations of gelatin/gum arabic, gelatin/acacia, gelatin/pectin, gelatin/carbopol, heparin/gelatin, gelatin/carboxymethylcellulose, B-lactoglobulin/gum arabic or guar/dextran.

With very particular preference, gelatin or gelatin/gum arabic mixtures are used as hydrophilic colloids for performing the process of the invention.

When performing the process of the invention the general procedure is first to prepare an aqueous solution of one or more hydrophilic colloids. The concentration of the hydrophilic colloids used in this case can be varied within a broad range. Generally speaking, 0.05% to 30% by weight of at least one colloid are used, based on the aqueous solution. It is preferred to use 0.2% to 20% by weight and more preferably 0.5% to 15% by weight of hydrophilic colloid, based on the aqueous solution. In this colloid solution the iodopropargyl compound for coacervation is emulsified or suspended. This can be accomplished by stirring and grinding. It is also possible, however, to add the colloid solution to the iodopropargyl compound to be coacervated. In this context the iodopropargyl compound, depending on the temperature chosen, may be present in the form of a solid or a melt.

The iodopropargyl compound to be coacervated is used generally in a concentration of 0.5% to 50% by weight, based on the aqueous solution. Preference is given to using 1% to 40% by weight and more preferably 2% to 30% by weight of the iodopropargyl compound, based in each case on the aqueous solution.

The temperature for performing the process of the invention can be varied within a wide range. In general, in step (a), the mixture, more particularly emulsion or suspension, of hydrophilic colloid and iodopropargyl compound is prepared at a temperature of 0 to 90° C.

The emulsion or suspension is prepared preferably at a temperature of 10° C. to 80° C. and more preferably at a temperature of 15 to 70° C.

When using one or more hydrophilic colloids suitable for simple coacervation, an acidic pH, more preferably a pH of 3 to 5, is generally set. This can be done by means of all typical organic or inorganic acids, preferably by hydrochloric acid, sulfuric acid, phosphoric acid, citric acid, acetic acid, formic acid. The acids are used in an amount necessary to set the desired pH.

In certain cases, such as that of complex coacervation with gum arabic as the colloid used, for example, it may be necessary, on grounds of solubility, first to set an alkaline pH, but to reacidify the pH prior to the actual coacervation.

The coacervation step (b) of the process of the invention then takes place by addition of coacervating aids and/or by changing of the ambient conditions. By this means the hydrophilic colloids are then precipitated or deposited on the particle surfaces of the iodopropargyl compounds. By the changing of the ambient conditions is meant, for example, lowering of temperature or changing of the pH.

Coacervating aids for the purposes of the present invention are salts, polyelectrolytes, alcohols, acetone, and polyethylene glycol or combinations thereof.

With particular preference, in the context of the performance of the process of the invention, the coacervation is carried out by adding salts, raising the pH or lowering the temperature, or combinations thereof.

Suitable salts are in principle all inorganic salts. It is preferred, however, to use salts of the cations sodium, potassium, rubidium, cesium, ammonium or lithium and the anions sulfate, citrate, tartrate, formate, acetate, bromide, phosphate, carbonate or chloride. With particular preference mention may be made of sodium sulfate, citrate, tartrate, acetate and chloride and potassium sulfate, citrate, tartrate, acetate and chloride. The addition of the salts takes place preferably in the form of aqueous solutions at a temperature in the range from 0 to 50° C. The concentration of the salt solution can be varied within a broad range. This concentration can be determined, for example, by adding the salt solution to the solution of the hydrophilic colloid material that as yet contains no iodopropargyl compound. The concentration at which clouding occurs is the correct salt concentration for the coacervation. In general the concentration is from 0.005% to 10% by weight, based on the solution to be coacervated.

Coacervation by an increase in pH can take place by the addition of an alkaline solution. pH of >=10 can be set preferably by addition of an aqueous sodium hydroxide, potassium hydroxide, lithium hydroxide, sodium carbonate or potassium carbonate solution. The addition of the alkaline solution takes place in general at a temperature in the range from 0 to 50° C.

Coacervation by temperature reduction can be accomplished by cooling the emulsion or suspension. Either by external cooling or mixing with a colder medium, such as ice-water, for example. The temperature in this case is lowered from 0° C.-90° C. to −5-10° C.

The coacervates obtained can either be utilized directly in the medium in which they have been coacervated; it is also possible, however, to isolate and purify the particles. The coacervates can be isolated by filtration, centrifugation or digestion. Further provided by the present invention, therefore, are the coacervated iodopropargyl compounds prepared by the process of the invention.

The coacervates are generally used in dispersion in aqueous systems, though it is also possible to isolate the coacervates in solid form.

With very particular preference it is possible to coacervate iodopropargyl compounds by starting with an emulsion at a temperature above the melting temperature of the respective iodopropargyl compounds, in a range of 65° C.-90° C., at a pH in the range of 3-5. The polymer used is preferably gelatin (simple coacervation) or the gelatin/gum arabic combination (complex coacervation). Coacervation takes place by lowering of the temperature to 0° C.-10° C. alone and/or subsequently changing the pH to >10 in the case of complex coacervation.

With very particular preference a 4% iodopropargyl compound/water emulsion is used which is admixed with 25% strength gelatin solution (0.45 g of gelatin per g of iodopropargyl compound) and at 40° C. the pH is set to 4.5 using a 0.1 mol/l HCl. At a temperature of 70° C. the emulsion is dispersed with an ultrasound probe (tip 5 mm, 2*15 s, 35%). Coacervation takes place by lowering the temperature, by dispersing the emulsion in ice-water using an Ultraturrax (9000 min⁻¹) and, by so doing, lowering the temperature to 0° C.

For complex coacervation, before the addition of gum arabic, the pH is raised to 10 with a 0.5 mol/l NaOH and the temperature is raised to 45° C. Following the addition of warm 25% strength gelatin solution, the pH is lowered to 4 with a 0.5 mol/l HCl and cooling takes place to room temperature with stirring. The capsules are hardened over the course of 2 h in an ice bath.

The coacervate shells of the coacervated iodopropargyl compounds prepared by the process of the invention can be crosslinked if desired, by means of which it is possible in certain cases to increase the stability of the coacervates. The crosslinking of the coacervate shells is generally carried out by reaction with aldehydes or by complexation with metal cations, by adding these substances subsequently to the coacervates. After a reaction time of 16-96 hours, the crosslinked, coacervated iodopropargyl compounds are washed with water and isolated if desired by filtration, centrifugation or digestion.

The crosslinking is carried out preferably with aldehydes, more particularly with 1,5-pentanedial (glutaraldehyde), methanol (formaldehyde). The concentration of the aldehydes is generally 10% by weight to 100% by weight, based on the iodopropargyl compound to be coacervated, preferably 30% by weight to 70% by weight.

The temperature for the crosslinking reaction is generally from 10° C. to 50° C., preferably from 20° C.-30° C.

The crosslinking reaction is carried out for a period of 24 to 72 hours with continual stirring.

With very particular preference the crosslinking is carried out with 50% strength glutaraldehyde solution (0.5 g of glutaraldehyde per g of solid in suspension) at a temperature of 25° C. for a reaction time of 48 h with continual shaking. The excess glutaraldehyde is removed in a plurality of washing and centrifuging steps with water.

In principle the process of the invention for coacervation can be applied to all iodopropargyl compounds. The process serves preferably for coacervating 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, 3-iodo-2-propynyl-2,4,5-trichlorophenyl ether, 3-iodo-2-propynyl 4-chlorophenyl formal (IPCF), di(3-iodo-2-propynyl)hexyl dicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynylcarbamic esters (IPC), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 4-chlorophenyl 3-iodopropargyl formal, 3-iodo-2-propynyl n-hexylcarbamate, 3-iodo-2-propynyl cyclohexylcarbamate.

With very particular preference the method can be applied to 3-iodo-2-propynyl butylcarbamate (IPBC).

The coacervated iodopropargyl compounds of the invention are outstandingly suitable as biocides for protecting industrial materials from infestation and/or destruction by microorganisms.

The present invention further provides for the use of coacervated iodopropargyl compounds to protect industrial materials from infestation and/or destruction by microorganisms.

The coacervated iodopropargyl compounds of the invention are suitable for protecting industrial materials. By industrial materials in the present context are meant nonliving materials which have been prepared for use in industry. The industrial materials are for example adhesives, glues, paper and cardboard, textiles, leather, wood, woodbase materials, coating materials and plastic articles, cooling lubricants and other materials which may be infested or decomposed by microorganisms.

Examples of microorganisms which may bring about degradation or alteration of the industrial materials include bacteria, fungi, yeasts, algae, and slime organisms. The actives of the invention act preferably against fungi, more particularly molds, wood-discoloring and wood-destroying fungi (Basidiomycetes) and also against slime organisms and bacteria.

Microorganisms of the following genera may be mentioned by way of example:

Alternaria, such as Alternaria tenuis,
Aspergillus, such as Aspergillus niger,
Chaetomium, such as Chaetomium globosum,
Coniophora, such as Coniophora puetana,
Lentinus, such as Lentinus tigrinus,
Penicillium, such as Penicillium glaucum,
Polyporus, such as Polyporus versicolor,
Aureobasidium, such as Aureobasidium pullulans,
Sclerophoma, such as Sclerophoma pityophila,
Trichoderma, such as Trichoderma viride,
Escherichia, such as Escherichia coli,
Pseudomonas, such as Pseudomonas aeruginosa,
Staphylococcus, such as Staphylococcus aureus.

Depending on their respective physical and/or chemical properties, the coacervated iodopropargyl compounds of the invention can furthermore be converted into the typical formulations, such as solutions, emulsions, suspensions, powders, foams, pastes, granules, aerosols and ultrafine encapsulations in polymeric substances.

These formulations can be prepared in a known manner, for example by mixing the individual actives with extenders, i.e. liquid solvents, liquefied gases under pressure, and/or solid carriers, if appropriate with the use of surfactants, i.e., emulsifiers and/or dispersants and/or foam-formers. If the extender used is water, it is also possible to use, for example, organic solvents as auxiliary solvents. Essentially, suitable liquid solvents are: aromatics, such as xylene, toluene or alkylnaphthalenes, chlorinated aromatics or chlorinated aliphatic hydrocarbons, such as chlorobenzenes, chloroethylene or methylene chloride, aliphatic hydrocarbons, such as cyclohexane or paraffins, for example mineral oil fractions, alcohols, such as butanol or glycol and their ethers and esters, ketones, such as acetone, methyl ethyl ketone, methyl isobutyl ketone or cyclohexanone, strongly polar solvents, such as dimethylformamide and dimethyl sulfoxide, and water. By liquefied gaseous extenders or carriers are meant liquids which are gaseous at ambient temperature and under atmospheric pressure, for example aerosol propellants, such as halogenated hydrocarbons and butane, propane, nitrogen and carbon dioxide. Suitable solid carriers are: for example ground natural minerals, such as kaolins, clays, talc, chalk, quartz, attapulgite, montmorillonite or diatomaceous earth, and ground synthetic minerals, such as finely divided silica, alumina and silicates.

Suitable solid carriers for granules are: for example crushed and fractionated natural rocks such as calcite, marble, pumice, sepiolite and dolomite, and synthetic granules of organic and inorganic meals, and granules of organic material such as sawdust, coconut shells, maize cobs and tobacco stalks. Suitable emulsifiers and/or foam-formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and protein hydrolysates. Suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and natural phospholipids, such as cephalins and lecithins, and synthetic phospholipids, can be used in the formulations. Other possible additives are mineral and vegetable oils.

It is possible to use colorants such as inorganic pigments, for example iron oxide, titanium oxide and Prussian blue, and organic dyes, such as alizarin dyes, azo dyes and metal phthalocyanine dyes, and trace nutrients such as salts of iron, manganese, boron, copper, cobalt, molybdenum and zinc.

The formulations contain generally between 0.1 and 95 percent by weight of actives mixture, preferably between 2 and 75 percent by weight.

The present invention further provides microbicidal compositions based on the coacervated iodopropargyl compounds of the invention and comprising at least one solvent or diluent and also, if appropriate, processing auxiliaries and, if appropriate, further antimicrobially active compounds. In this case, the actives may be present herein either in dissolved form or as suspensions or emulsions. The solvents or diluents are either water or all customary organic solvents.

The activity and the spectrum of action of coacervated iodopropargyl compounds and, respectively, of the compositions and precursors (masterbatches, for example) or, quite generally, formulations that can be prepared from them can be enhanced by adding, if appropriate, further antimicrobial compounds, fungicides, bactericides, herbicides, insecticides, algicides or other actives so as to broaden the spectrum of action or to obtain particular effects, such as, for example, additional protection from insects. These actives may if appropriate likewise be present in coacervated form in the mixture.

These mixtures may possess a broader spectrum of action than the compounds of the invention.

In many cases, synergistic effects are obtained in this case, i.e., the activity of the mixture of coacervated iodopropargyl compounds and one or more further actives is greater than the activity of the individual components. Particularly advantageous co-components are, for example, the following compounds:

triazoles such as:
azaconazole, azocyclotin, bitertanol, bromuconazole, cyproconazole, diclobutrazole, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazole, penconazole, propioconazole, prothioconazole, simeoconazole, (±)-cis-1-(4-chlorophenyl)-2-(1H-1,2,4-triazol-1-yl)cycloheptanol, 2-(1-tert-butyl)-1-(2-chlorophenyl)-3-(1,2,4-triazol-1-yl)propan-2-ol, tebuconazole, tetraconazole, triadimefon, triadimenol, triapenthenol, triflumizole, triticonazole, uniconazole and their metal salts and acid adducts;
imidazoles such as:
clotrimazole, bifonazole, climbazole, econazole, fenapamil, imazalil, isoconazole, ketoconazole, lombazole, miconazole, pefurazoate, prochloraz, triflumizole, thiazolcar, 1-imidazolyl-1-(4′-chlorophenoxy)-3,3-dimethylbutan-2-one, and their metal salts and acid adducts;
pyridines and pyrimidines such as:
ancymidol, buthiobate, fenarimol, mepanipyrin, nuarimol, pyvoxyfur, triamirol;
succinate dehydrogenase inhibitors such as:
benodanil, carboxim, carboxim sulfoxide, cyclafluramid, fenfuram, flutanil, furcarbanil, furmecyclox, mebenil, mepronil, methfuroxam, metsulfovax, nicobifen, pyracarbolid, oxycarboxin, Shirlan, Seedvax;
naphthalene derivatives such as:
terbinafine, naftifine, butenafine, 3-chloro-7-(2-aza-2,7,7-trimethyloct-3-en-5-yne);
sulfenamides such as:
dichlofluanid, tolylfluanid, folpet, fluorofolpet, captan, captofol;
benzimidazoles such as:
carbendazim, benomyl, fuberidazole, thiabendazole or their salts;
morpholine derivatives such as:
aldimorph, dimethomorph, dodemorph, falimorph, fenpropidin, fenpropimorph, tridemorph, trimorphamid and their arylsulfonate salts such as, for example, p-toluenesulfonic acid and p-dodecylphenylsulfonic acid;
benzothiazoles such as:
2-mercaptobenzothiazole;
benzothiophene dioxides such as:
cyclohexyl-benzo[b]thiophenecarboxamide S,S-dioxide;
benzamides such as:
2,6-dichloro-N-(4-trifluoromethylbenzyl)benzamide, tecloftalam;
boron compounds such as:
boric acid, boric esters, borax;
formaldehyde and formaldehyde-releasing compounds such as:
benzyl alcohol mono(poly)hemiformal, 1,3-bis(hydroxymethyl)-5,5-dimethylimidazolidine-2,4-dione (DMDMH), bisoxazolidine, n-butanol hemiformal, cis-1-(3-chloroallyl)-3,5,7-triaza-1-azoniaadamantane chloride, 1-[1,3-bis(hydroxymethyl-2,5-dioxoimidazolidin-4-yl]-1,3-bis(hydroxymethyl)urea, dazomet, dimethylolurea, 4,4-dimethyloxazolidine, ethylene glycol hemiformal, 7-ethylbicyclooxazolidine, hexahydro-S-triazine, hexamethylenetetramine, N-hydroxymethyl-N′-methylthiourea, methylenebismorpholine, sodium N-(hydroxymethyl)glycinate, N-methylolchloroacetamide, oxazolidine, paraformaldehyde, taurolin, tetrahydro-1,3-oxazine, N-(2-hydroxypropyl)-aminemethanol, tetramethylolacetylenediurea (TMAD);
isothiazolinones such as:
N-methylisothiazolin-3-one, 5-chloro-N-methylisothiazolin-3-one, 4,5-dichloro-N-octylisothiazolin-3-one, 5-chloro-N-octylisothiazolinone, N-octylisothiazolin-3-one, 4,5-trimethyleneisothiazolinone, 4,5-benzoisothiazolinone;
aldehydes such as:
cinnamaldehyde, formaldehyde, glutaraldehyde, β-bromocinnamaldehyde, o-phthalaldehyde;
thiocyanates such as:
thiocyanatomethylthiobenzothiazole, methylenebisthiocyanate;
quaternary ammonium compounds and guanidines such as:
benzalkonium chloride, benzyldimethyltetradecylammonium chloride, benzyldimethyldodecylammonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminoctadine tris(albesilate);
iodine derivatives such as:
diiodomethyl p-tolyl sulfone, 3-iodo-2-propynyl alcohol, 4-chlorophenyl-3-iodo-propargylformal, 3-bromo-2,3-diiodo-2-propenyl ethylcarbamate, 2,3,3-triiodoallyl alcohol, 3-bromo-2,3-diiodo-2-propenyl alcohol, 3-iodo-2-propynyl n-hexylcarbamate, 3-iodo-2-propynyl cyclohexylcarbamate, 3-iodo-2-propynyl phenylcarbamate;
phenols such as:
tribromophenol, tetrachlorophenol, 3-methyl-4-chlorophenol, 3,5-dimethyl-4-chlorophenol, dichlorophene, 2-benzyl-4-chlorophenol, triclosan, diclosan, hexachlorophene, methyl p-hydroxybenzoate, ethyl p-hydroxybenzoate, propyl p-hydroxybenzoate, butyl p-hydroxybenzoate, octyl p-hydroxybenzoate, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethyl-phenoxy)phenol and their alkali metal salts and alkaline earth metal salts;
microbicides with an activated halogen group such as:
bronopol, bronidox, 2-bromo-2-nitro-1,3-propanediol, 2-bromo-4′-hydroxyaceto-phenone, 1-bromo-3-chloro-4,4,5,5-tetramethyl-2-imidazolidinone, β-bromo-β-nitro-styrene, chloracetamide, chloramine T, 1,3-dibromo-4,4,5,5-tetramethyl-2-imidazoli-dinone, dichloramine T, 3,4-dichloro-(3H)-1,2-dithiol-3-one, 2,2-dibromo-3-nitrilepropionamide, 1,2-dibromo-2,4-dicyanobutane, halane, halazone, mucochloric acid, phenyl (2-chlorocyanovinyl) sulfone, phenyl (1,2-dichloro-2-cyanovinyl) sulfone, trichloroisocyanuric acid;
pyridines such as:
1-hydroxy-2-pyridinethione (and their Cu, Na, Fe, Mn, Zn salts), tetrachloro-4-methylsulfonylpyridine, pyrimethanol, mepanipyrim, dipyrithione, 1-hydroxy-4-methyl-6-(2,4,4-trimethylpentyl)-2(1H)-pyridine;
methoxyacrylates or similar such as:
azoxystrobin, dimoxystrobin, fluoxastrobin, kresoxim-methyl, metominostrobin, orysastrobin, picoxystrobin, pyraclostrobin, trifloxystrobin, 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one (CAS No. 185336-79-2);
metal soaps such as:
salts of the metals tin, copper and zinc with higher fatty acids, resin acids, naphthenoic acids and phosphoric acid, such as, for example, tin naphthenate, tin octoate, tin 2-ethylhexanoate, tin oleate, tin phosphate, tin benzoate, copper naphthenate, copper octoate, copper 2-ethylhexanoate, copper oleate, copper phosphate, copper benzoate, zinc naphthenate, zinc octoate, zinc 2-ethylhexanoate, zinc oleate, zinc phosphate, zinc benzoate;
metal salts such as:
salts of the metals tin, copper, zinc, and also chromates and dichromates, such as, for example, copper hydroxycarbonate, sodium dichromate, potassium dichromate, potassium chromate, copper sulphate, copper chloride, copper borate, zinc fluorosilicate, copper fluorosilicate;
oxides such as:
oxides of the metals tin, copper and zinc, such as, for example, tributyltin oxide, Cu₂O, CuO, ZnO;
oxidizing agents such as:
hydrogen peroxide, peracetic acid, potassium persulfate; dithiocarbamates such as:
cufraneb, ferban, potassium N-hydroxymethyl-N′-methyldithiocarbamate, sodium dimethyldithiocarbamate, potassium dimethyldithiocarbamate, mancozeb, maneb, metam, metiram, thiram, zineb, ziram;
nitriles such as:
2,4,5,6-tetrachloroisophthalonitrile, disodium cyanodithioimidocarbamate;
quinolines such as:
8-hydroxyquinoline and their copper salts;
other fungicides and bactericides such as:
bethoxazin, 5-hydroxy-2(5H)-furanone, 4,5-benzodithiazolinone, 4,5-trimethylene-dithiazolinone, N-(2-p-chlorobenzoylethyl)hexaminium chloride, 2-oxo-2-(4-hydroxyphenyl)acetohydroxycinnamoyl chloride, tris-N-(cyclohexyldiazenium-dioxy)-aluminium, N-(cyclohexyldiazeniumdioxy)-tributyltin or its potassium salts, bis-N-(cyclohexyldiazeniumdioxy)-copper; iprovalicarb, fenhexamide, spiroxamine, carpropamid, diflumetorin, quinoxyfen, famoxadone, polyoxorim, acibenzolar S-methyl, furametpyr, thifluzamide, methalaxy-M, benthiavalicarb, metrafenon, cyflufenamid, tiadinil, tea tree oil, phenoxyethanol,
Ag, Zn or Cu-containing zeolites alone or incorporated into polymeric materials.

Very especially preferred are mixtures with

azaconazole, bromuconazole, cyproconazole, dichlobutrazol, diniconazole, diuron, hexaconazole, metaconazole, penconazole, propiconazole, tebuconazole, dichlofluanid, tolylfluanid, fluorfolpet, methfuroxam, carboxin, cyclohexyl-benzo[b]thiophenecarboxamide S,S-dioxide, fenpiclonil, 4-(2,2-difluoro-1,3-benzodioxol-4-yl)-1H-pyrrole-3-carbonitrile, butenafine, imazalil, N-methyl-isothiazolin-3-one, 5-chloro-N-methylisothiazolin-3-one, N-octylisothiazolin-3-one, dichloro-N-octylisothiazolinone, mercaptobenzothiazole, thiocyanato-methylthiobenzothiazole, thiabendazole, benzoisothiazolinone, N-(2-hydroxypropyl)aminomethanol, benzyl alcohol (hemi)formal, N-methylol-chloroacetamide, N-(2-hydroxypropyl)aminemethanol, glutaraldehyde, omadine, Zn-omadine, dimethyl dicarbonate, 2-bromo-2-nitro-1,3-propanediol, bethoxazin, o-phthaldialdehyde, 2,2-dibromo-3-nitrile-propionamide, 1,2-dibromo-2,4-dicyano-butane, 1,3-bis(hydroxymethyl)-5,5-dimethylimidazolidine-2,4-dione (DMDMH), tetramethylolacetylenediurea (TMAD), ethylene glycol hemiformal, p-hydroxybenzoic acid, carbendazim, chlorophen, 3-methyl-4-chlorophenol, o-phenylphenol.

Apart from with the abovementioned fungicides and bactericides, mixtures with a good efficacy are, moreover, also prepared with other active compounds:

insecticides/acaricides/nematicides:
abamectin, acephate, acetamiprid, acetoprole, acrinathrin, alanycarb, aldicarb, aldoxycarb, aldrin, allethrin, alpha-cypermethrin, amidoflumet, amitraz, avermectin, azadirachtin, azinphos A, azinphos M, azocyclotin,
Bacillus thuringiensis, barthrin, 4-bromo-2(4-chlorophenyl)-1-(ethoxymethyl)-5-(tri-fluoromethyl)-1H-pyrrole-3-carbonitrile, bendiocarb, benfuracarb, bensultap, beta-cyfluthrin, bifenthrin, bioresmethrin, bioallethrin, bistrilfluoron, bromophos A, bromophos M, bufencarb, buprofezin, butathiophos, butocarboxim, butoxycarboxim,
cadusafos, carbaryl, carbofuran, carbophenothion, carbosulfan, cartap, quino-methionate, cloethocarb, 4-chloro-2-(2-chloro-2-methylpropyl)-5-[(6-iodo-3-pyridinyl)methoxy]-3(2H)-pyridazinone (CAS RN: 120955-77-3), chlordane, chlorethoxyfos, chlorfenapyr, chlorfenvinphos, chlorfluazuron, chlormephos, N-[(6-chloro-3-pyridinyl)methyl]-N′-cyano-N-methylethaneimidamide, chlorpicrin, chlorpyrifos A, chlorpyrifos M, cis-resmethrin, clocythrin, clothiazoben, cypophenothrin, clofentezin, coumaphos, cyanophos, cycloprothrin, cyfluthrin, cyhalothrin, cyhexatin, cypermethrin, cyromazin,
decamethrin, deltamethrin, demeton M, demeton S, demeton-S-methyl, diafenthiuron, dialiphos, diazinon, 1,2-dibenzoyl-1(1,1-dimethyl)hydrazine, DNOC, dichlofenthion, dichlorvos, dicliphos, dicrotophos, difethialone, diflubenzuron, dimethoate, 3,5-dimethylphenyl methylcarbamate, dimethyl(phenyl)silylmethyl-3-phenoxybenzyl ether, dimethyl(4-ethoxyphenyl)silylmethyl-3-phenoxybenzyl ether, dimethylvinphos, dioxathion, disulfoton,
eflusilanate, emamectin, empenthrin, endosulfan, EPN, esfenvalerate, ethiofencarb, ethion, ethofenprox, etrimphos, etoxazole, etobenzanid,
fenamiphos, fenazaquin, fenbutatin oxide, fenfluthrin, fenitrothion, fenobucarb, fenothiocarb, fenoxycarb, fenpropathrin, fenpyrad, fenpyroximate, fensulfothion, fenthion, fenvalerate, fipronil, flonicamid, fluacrypyrim, fluazuron, flucycloxuron, flucythrinate, flufenerim, flufenoxuron, flupyrazofos, flufenzine, flumethrin, flufenprox, fluvalinate, fonophos, formethanate, formothion, fosmethilan, fosthiazate, fubfenprox, furathiocarb,
halofenozide, HCH, (CAS RN: 58-89-9), heptenophos, hexaflumuron, hexythiazox, hydramethylnon, hydroprene,
imidacloprid, imiprothrin, indoxycarb, iodfenfos, iprinomectin, iprobenfos, isazophos, isoamidophos, isofenphos, isoprocarb, isoprothiolane, isoxathion, ivermectin,
kadedrin
lambda-cyhalothrin, lufenuron,
malathion, mecarbam, mervinphos, mesulfenphos, metaldehyde, methacrifos, methamidophos, methidathion, methiocarb, methomyl, metolcarb, milbemectin, monocrotophos, moxiectin,
naled, NI 125, nicotine, nitenpyram, noviflumuron,
omethoate, oxamyl, oxydemethon M, oxydeprofos,
parathion A, parathion M, penfluoron, permethrin, 2-(4-phenoxyphenoxy)ethyl ethylcarbamate, phenthoate, phorate, phosalon, phosmet, phosphamidon, phoxim, pirimicarb, pirimiphos M, pirimiphos A, prallethrin, profenophos, promecarb, propa-phos, propoxur, prothiophos, prothoate, pymetrozin, pyrachiophos, pyridaphenthion, pyresmethrin, pyrethrum, pyridaben, pyridalyl, pyrimidifen, pyriproxifen, pyrithiobac-sodium,
quinalphos,
resmethrin, rotenone,
salithion, sebufos, silafluofen, spinosad, spirodiclofen, spiromesifen, sulfotep, sulprofos,
tau-fluvalinate, taroils, tebufenozide, tebufenpyrad, tebupirimphos, teflubenzuron, tefluthrin, temephos, terbam, terbufos, tetrachlorvinphos, tetramethrin, tetra-methacarb, thiacloprid, thiafenox, thiamethoxam, thiapronil, thiodicarb, thiofanox, thiazophos, thiocyclam, thiomethon, thionazin, thuringiensin, tralomethrin, transfluthrin, triarathen, triazophos, triazamate, triazuron, trichlorfon, triflumuron, trimethacarb,
vamidothion, xylylcarb, zetamethrin;
molluscicides:
fentin acetate, metaldehyde, methiocarb, niclosamide;
herbicides and algicides:
acetochlor, acifluorfen, aclonifen, acrolein, alachlor, alloxydim, ametryn, amidosulfuron, amitrole, ammonium sulfamate, anilofos, asulam, atrazine, azafenidin, aziptrotryne, azimsulfuron,
benazolin, benfluralin, benfuresate, bensulfuron, bensulfide, bentazone, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoyl-prop, bromobutide, butroxydim,
carbetamide, carfentrazone-ethyl, carfenstrole, chlomethoxyfen, chloramben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamid, cinmethylin, cinosulfuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulfamuron,
diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamid, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamid, dithiopyr, dimethametryn,
eglinazine, endothal, EPTC, esprocarb, ethalfluralin, ethidimuron, ethofumesate, ethobenzanid, ethoxyfen, ethametsulfuron, ethoxysulfuron,
fenoxaprop, fenoxaprop-P, fenuron, flamprop, flamprop-M, flazasulfuron, fluazifop, fluazifop-P, fuenachlor, fluchloralin, flufenacet, flumeturon, fluorocglycofen, fluoronitrofen, flupropanate, flurenol, fluridone, fluorochloridone, fluoroxypyr, fomesafen, fosamine, fosametine, flamprop-isopropyl, flamprop-isopropyl-L, flufenpyr, flumiclorac-pentyl, flumipropyn, flumioxzim, flurtamone, flumioxzim, flupyrsulfuron-methyl, fluthiacet-methyl,
glyphosate, glufosinate-ammonium
haloxyfop, hexazinone,
imazamethabenz, isoproturon, isoxaben, isoxapyrifop, imazapyr, imazaquin, imazethapyr, ioxynil, isopropalin, imazosulfuron, imazomox, isoxaflutole, imazapic,
ketospiradox,
lactofen, lenacil, linuron,
MCPA, MCPA-hydrazide, MCPA-thioethyl, MCPB, mecoprop, mecoprop-P, mefenacet, mefluidide, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, monalide, monolinuron, MSMA, metolachlor, metosulam, metobenzuron,
naproanilide, napropamide, naptalam, neburon, nicosulfuron, norflurazon, sodium chlorate,
oxadiazon, oxyfluorfen, oxysulfuron, orbencarb, oryzalin, oxadiargyl,
propyzamide, prosulfocarb, pyrazolate, pyrazosulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachior, propanil, propaquizafob, propazine, propham, propisochlor, pyriminobac-methyl, pelargonic acid, pyrithiobac, pyraflufen-ethyl,
quinmerac, quinocloamine, quizalofop, quizalofop-P, quinchlorac,
rimsulfuron
sethoxydim, sifuron, simazine, simetryn, sulfosulfuron, sulfometuron, sulfentrazone, sulcotrione, sulfosate,
tar oils, TCA, TCA-sodium, tebutam, tebuthiuron, terbacil, terbumeton, terbuthylazine, terbutryn, thiazafluoron, thifensulfuron, thiobencarb, thiocarbazil, tralkoxydim, triallate, triasulfuron, tribenuron, triclopyr, tridiphane, trietazine, trifluoralin, tycor, thdiazimin, thiazopyr, triflusulfuron,
vernolates.

The weight ratios of the actives in these actives combinations can be varied within relatively wide ranges.

Preferably the ratio of coacervated iodopropargyl compounds to the co-components is in general between 50:1 and 1:50, preferably in a ratio of 20:1 to 1:20, with particular preference, in a ratio of 10:1 to 1:10.

The mixtures can in one case be obtained by mixing them with one another even prior to coacervation and then subjecting them to joint coacervation, which means that all of the actives of the mixture are coacervated. In another, alternative case it is possible to add the solid or liquid actives to the iodopropargyl compounds which have already been coacervated, or vice versa. Alternatively the co-components can be formulated by themselves, in the form of emulsions, suspensions or solutions, for example, and then mixed with the coacervates. In order not to destroy the coacervates again, high shearing forces, as occur, for example, in the case of milling, should be avoided.

The microbicidal compositions, formulations or concentrates used to protect the industrial materials contain the coacervated iodopropargyl compounds, or the mixtures of coacervated iodopropargyl compounds with other actives, in a concentration of 0.01% to 95% by weight, more particularly 0.01% to 60% by weight.

The concentrations in which the coacervated iodopropargyl compounds or combinations used are employed are governed by the nature and the incidence of the microorganisms to be controlled and also by the composition of the material to be protected. The optimum amount for use can be determined by means of test series. In general the concentrations for application are situated in the range from 0.001% to 5% by weight, preferably from 0.05% to 2.0% by weight, based on the material to be protected.

The examples which follow serve to illustrate the present invention, though without restricting it to them. The unit for the percentages is always percent by weight, unless any other unit is expressly indicated.

### EXAMPLES

### Example 1

### Noninventive, Comparative Example of a Dispersion of IPBC in Water without Coacervation

A glass beaker was charged with 20 g of suspension consisting of 19.8 g of water and 0.2 g of micronized IPBC (1% based on suspension). Dispersion took place by means of an Ultraturrax of approximately 9000 min⁻¹ with a dispersing time of 2 minutes. The dispersion was stored at 40° C. In order to be able to determine microscopic changes in the sample during storage, it was investigated by light microscopy at regular intervals. After 5 days at 40° C., distinct crystal growth was already observed.

### Example 2

### Noninventive, Comparative Example, Dispersion of IPBC with Mowiol 18-88, Partially Hydrolyzed Polyvinyl Acetate, in Analogy to WO 00/57702

A glass beaker was charged with 20.52 g of suspension consisting of 17.4 g of water, 2.6 g of micronized IPBC (12.7% based on suspension) and 0.52 g of Mowiol 18-88 (1% based on active substance). Dispersion took place by means of an Ultraturrax of approximately 9000 min⁻¹ with a dispersing time of 2 minutes. The sample was stored at 40° C. In order to be able to determine microscopic changes in the sample during storage, it was investigated by light microscopy at regular intervals. After 7 days at 40° C. slight crystal growth was observed.

### Example 3

### Simple Coacervation of IPBC, Incorporation of Ice-Water into the Formulation, Round Aggregates

1.8 g of a hot 25% strength gelatin solution (Gelita bloom 300 Pharma, type A-gelatin from Stoess) were added to 24 g of distilled water. 1.2 g of sodium chloride solution (1 molar) and 1 g of IPBC were added. The sample was heated to a temperature of approximately 40° C. by means of a magnetic stirrer with heating. When the desired temperature was reached, the pH was adjusted to about 4.5 (with a 0.1 molar HCl solution). The suspension was then heated to about 65° C. in a hot water bath (magnetic stirrer) at 85° C. When the IPBC was in liquid form, there was also a short dispersion step with an Ultraturrax with an emulsion rod (1 min at 9000 rpm). In the course of dispersion, 120 g of ice-water were added very quickly. Addition of the ice-water was followed by stirring for approximately 30 seconds (Ultraturrax at 9000 rpm). Finally, the sample was cooled in an ice bath for around 2 hours with gentle stirring.

In order to be able to determine microscopic changes in the sample during storage, it was investigated by light microscopy at regular intervals. After 2 weeks at 40° C. no significant crystal growth was observed.

The sample was assayed for the bioavailability of the IPBC active (see example 9). The biological activity in the coating showed no significant difference in relation to IPBC incorporated directly.

### Example 4

### Simple Coacervation of IPBC, Incorporation of the Formulation into Ice-Water, Small Particles

1.8 g of a hot 25% strength gelatin solution (Gelita bloom 300 Pharma, type A-gelatin from Stoess) were added to 24 g of distilled water. 1 g of IPBC was added. The sample was heated to a temperature of approximately 40° C. by means of a magnetic stirrer with heating. When the desired temperature was reached, the pH was adjusted to about 4.5 (with a 0.1 molar HCl solution). The suspension was then heated to about 65° C. in a hot water bath (magnetic stirrer) at 85° C. When the active was in liquid form, there was also a dispersion step with an ultrasound probe (Branson 250D, ultrasound probe 5 mm 2*15 sec at 35%). 85 g of ice-water were introduced in a glass beaker. The hot emulsion was added by slow dropwise addition. In the course of this addition the initial charge was homogenized by means of an Ultraturrax with an emulsion rod (at 9000 rpm). Finally, the sample was cooled in an ice bath for around 2 hours with gentle stirring.

In order to be able to determine microscopic changes in the sample during storage, it was investigated by light microscopy at regular intervals. After 2 weeks at 40° C. no significant crystal growth was observed.

The sample was assayed for the bioavailability of the IPBC active (see example 9). The biological activity in the coating showed no significant difference in relation to IPBC incorporated directly.

### Example 5

### Complex Coacervation of IPBC

1.8 g of a hot 25% strength gelatin solution (Gelita bloom 300 Pharma, type A-gelatin from Stoess) were added to 24 g of distilled water. 1 g of IPBC was added. The sample was heated to a temperature of approximately 40° C. by means of a magnetic stirrer with heating. When the desired temperature was reached, the pH was adjusted to about 4.5 (with a 0.1 molar HCl solution). The suspension was then heated to about 65° C. in a hot water bath (magnetic stirrer) at 85° C. When the active was in liquid form, there was also a dispersion step with an ultrasound probe (Branson 250D, ultrasound probe 5 mm 2*15 sec at 35%). 170 g of ice-water were introduced in a glass beaker. The hot emulsion was added by slow dropwise addition. In the course of this addition the initial charge was homogenized by means of an Ultraturrax with an emulsion rod (at 9000 rpm). After addition of the ice-water, stirring took place for approximately 30 seconds (Ultraturrax at 9000 rpm) and cooling was carried out in an ice bath for approximately 30 minutes (gentle stirring). Prior to the addition of 8.3 g of gum arabic (3% in water) there was a change made in the pH to around 10 by means of 0.5 molar NaOH. The sample was heated to a temperature of 45° C. Then 1 g of a hot 25% strength gelatin solution (Gelita Blook 300 Pharma, type A gelatin from Stoess) was added. With vigorous stirring using a magnetic stirrer, the pH was slowly adjusted to 4 by means of 0.5 molar HCl. The sample was cooled at RT with stirring slowly down to room temperature. Then room temperature was reached, the capsules were hardened in an ice bath over a period of around two hours.

In order to be able to determine microscopic changes in the sample during storage, it was investigated by light microscopy at regular intervals. After 2 weeks at 40° C. no significant crystal growth was observed.

The sample was assayed for the bioavailability of the IPBC active. The biological activity showed no significant difference in relation to IPBC incorporated directly (see example 9).

### Example 6

### Mixture of IPBC, N-Octylisothiazolinone, and Cybutryn, Simple Coacervation with Crosslinking

A suspension was prepared as described in example 3. The sample was subsequently centrifuged in a Beckman J30 I centrifuge (2 min at 2000 g). After the supernatant had been separated off, the content of active in the sample was ascertained and it was diluted to 13% with water. Then 1.2 g of a 50% strength glutaraldehyde solution were added to 10 g of the suspension. The sample was then shaken at RT for around 48 h. In order to remove the excess glutaraldehyde, a number of washing and centrifuging steps followed (2 min at 2000 g). After the final washing step, 2.75 g of water were stripped off and 1.75 g of NOIT emulsion (20%, 6% Emulgator WN emulisfier and 6% Soprophor FL) and 1 g of cybutryn suspension (50%, 6% Emulgator WN emulsifier and 6 Soprophor FL) were added.

Subsequently the sample was stored in a shaken water bath at 40° C.

In order to be able to determine microscopic changes in the sample during storage, it was investigated by light microscopy at regular intervals. After 28 days of storage at 40° C. no heteroflocculation was observed.

### Example 7

### Mixture of IPBC, N-Octylisothiazolinone, and Cybutryn, Simple Coacervation with Crosslinking, Small Particles)

A suspension was prepared as described in example 4. The sample was subsequently centrifuged in a Beckman J30 I centrifuge (2 min at 2000 g). After the supernatant had been separated off, the content of IPBC in the sample was ascertained and it was diluted to 13% with water. Then 1.2 g of a 50% strength glutaraldehyde solution were added to 10 g of the suspension. The sample was then shaken at RT for around 48 h. In order to remove the excess glutaraldehyde, a number of washing and centrifuging steps followed (2 min at 2000 g). After the final washing step, 2.75 g of water were stripped off and 1.75 g of NOIT emulsion (20%, 6% Emulgator WN emulisfier and 6% Soprophor FL) and 1 g of cybutryn suspension (50%, 6% Emulgator WN emulsifier and 6 Soprophor FL) were added.

Subsequently the sample was stored in a shaken water bath at 40° C.

In order to be able to determine microscopic changes in the sample during storage, it was investigated by light microscopy at regular intervals. After 28 days of storage at 40° C. no heteroflocculation was observed.

### Example 8

### Mixture of IPBC, N-Octylisothiazolinone, and Cybutryn, Complex Coacervation with Crosslinking, Small Particles

A suspension was prepared as described in example 5. The sample was subsequently centrifuged in a Beckman J30 I centrifuge (2 min at 2000 g). After the supernatant had been separated off, the content of IPBC in the sample was ascertained and it was diluted to 13% with water. Then 1.2 g of a 50% strength glutaraldehyde solution were added to 10 g of the suspension. The sample was then shaken at RT for around 48 h. In order to remove the excess glutaraldehyde, a number of washing and centrifuging steps followed (2 min at 2000 g). After the final washing step, 2.75 g of water were stripped off and 1.75 g of NOIT emulsion (20%, 6% Emulgator WN emulsifier and 6% Soprophor FL) and 1 g of cybutryn suspension (50%, 6% Emulgator WN emulsifier and 6 Soprophor FL) were added. Subsequently the sample was stored in a shaken water bath at 40° C.

In order to be able to determine microscopic changes in the sample during storage, it was investigated by light microscopy at regular intervals. After 28 days of storage at 40° C. no heteroflocculation was observed.

### Example 9

### Coatings Tests

The substance under test was incorporated into the test paint, at the stated concentration, using a dissolver.

The procedure for testing the emulsion paints for mold resistance was as follows:

The coating material under test was applied to both sides of a suitable substrate. In order to obtain realistic results, one portion of the test specimens was leached with running water (24 h, 20° C.) prior to the test for mold resistance; a further portion was treated with a warm stream of fresh air (7 days, 40° C.).

The samples thus prepared were then placed on an agar nutrient medium, and both samples and nutrient medium were contaminated with fungal spores. Inspection took place after 2-3 weeks' storage (29±1° C., 80-90% relative humidity).

The coating is classed as permanently mold-resistant when the sample remains fungus-free or reveals at most a slight infestation at the margins.

Contamination was carried out using spores of the following mold fungi which are known to destroy coating materials or which are frequently encountered on coatings:

Alternaria tennis
Aspergillus flavus
Aspergillus niger
Aspergillus ustus
Cindosporum herbarum
Paecilomyces variotii
Penicillum citrium
Aureobasidium pullulans
Stachybotrys chartarum

Without leaching and wind tunnel exposure the coatings as per formula A which contained 0.08% (based on solids content of the emulsion paint) of pure IPBC or coacervated IPBC from examples 3, 4 and 5 were mold-resistant. After leaching and wind tunnel exposure the coatings of formula A which contained 0.16% (based on solids content of the emulsion paint) of pure IPBC or coacervated IPBC from examples 3, 4 and 5 were active.

### Formula A: Exterior Emulsion Paint Based on Acronal 290 D (Styrene Acrylate)

| Tradename | Parts by weight | Chemical name |
|---|---|---|
| Bayer Titan RKB2 | 40 | Titanium dioxide |
| Talkum V58 neu | 10 | Magnesium silicate, |
| | | hydrous |
| Durcal 5 | 45 | Calcite CaCO₃ |
| Walsroder MC 3000 S 2% | 30 | Methylcellulose |
| H₂O | 6.5 | Distilled water |
| Calgon N 10% | 3 | Polyphosphate |
| Pigmentverteiler A 10% | 1 | Polyacrylic acid salt, |
| | | pigment dispersant |
| Agitan 281, 1.1 in texanol | 1 | |
| White spirit | 5 | Mixture of aliphatic |
| | | hydrocarbons |
| Butylglycol acetate | 1.5 | Butyl glycol acetate |
| Acronal 290 D (binder) | 71 | Polyacrylate |
| Total | 219 | |

Solids content 135.5 = 61.6%

1. A process for coacervating iodopropargyl compounds, characterized in that
a) an aqueous solution of one or more hydrophilic colloids is mixed with at least one iodopropargyl compound and
b) by adding coacervating aids and/or by changing the ambient conditions of the reaction mixture, the hydrophilic colloids are precipitated or deposited on the particle surface of the iodopropargyl compounds, and
c) if desired, the coacervate shells of the coacervated iodopropargyl compounds thus prepared are crosslinked.

2. The process as claimed in claim 1, characterized in that hydrophilic colloids used are gelatin, agar-agar, albumin, cellulose derivatives, carraghenan, chitosan, soy protein, polyvinyl alcohol, gliadin, starch, or the combinations of gelatin/gum arabic, gelatin/acacia, gelatin/pectin, gelatin-carbopol, heparin/gelatin, gelatin/carboxymethylcellulose, B-lactoglobulin/gum arabic or guar/dextran.

3. The process as claimed in at least one of claims 1 and 2, characterized in that step a) is carried out at a pH in the range from 3 to 5.

4. The process as claimed in at least one of claims 1 to 3, characterized in that in step a) the iodopropargyl compound is used in an amount of 0.5% to 50% by weight, based on the aqueous solution of one or more hydrophilic colloids.

5. The process as claimed in at least one of claims 1 to 4, characterized in that in step a) the concentration of the hydrophilic colloid in the aqueous solution is 0.05% to 30% by weight.

6. The process as claimed in at least one of claims 1 to 5, characterized in that step a) takes place at a temperature of 0 to 90° C.

7. The process as claimed in at least one of claims 1 to 6, characterized in that in step b) coacervation aids used are salts, polyelectrolytes, alcohols, acetone, and polyethylene glycol or combinations thereof.

8. The process as claimed in at least one of claims 1 to 7, characterized in that in step b) the change in the ambient conditions of the reaction mixture takes place by raising of the pH to >10 and/or by lowering of the temperature to −5 to 10° C.

9. The process as claimed in at least one of claims 1 to 8, characterized in that use is made as iodopropargyl compound of 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, 3-iodo-2-propynyl-2,4,5-trichlorophenyl ether, 3-iodo-2-propynyl 4-chlorophenyl formal (IPCF), di(3-iodo-2-propynyl)hexyl dicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynylcarbamic esters (IPC), N-iodopropargyloxycarbonylalanine, N-iodopropargyloxycarbonylalanine ethyl ester, 3-(3-iodopropargyl)-benzoxazol-2-one, 3-(3-iodopropargyl)-6-chlorobenzoxazol-2-one, 4-chlorophenyl 3-iodopropargyl formal, 3-iodo-2-propynyl n-hexylcarbamate, 3-iodo-2-propynyl cyclohexylcarbamate or mixtures thereof.

10. The process as claimed in at least one of claims 1 to 9, characterized in that in step c) the crosslinking takes place by reaction with at least one aldehyde.

11. Coacervated iodopropargyl compounds obtainable by the process as claimed in at least one of claims 1 to 10.

12. Microbicidal compositions comprising at least one coacervated iodopropargyl compound as claimed in claim 11, at least one solvent or diluent, and also, if desired, processing auxiliaries and, if desired, further antimicrobial compounds.

13. The use of coacervated iodopropargyl compounds as claimed in claim 11 or compositions as claimed in claim 12 for protecting industrial materials from infestation and/or destruction by microorganisms.

14. Stable aqueous dispersions comprising at least one coacervated iodopropargyl compound as claimed in claim 11.

15. Mixtures comprising at least one coacervated iodopropargyl compound as claimed in claim 11 and at least one further biocidal active from the series consisting of fungicides, bactericides, herbicides, insecticides, and algicides.

16. A process for preparing a mixture as claimed in claim 15, characterized in that
a) an aqueous solution of one or more hydrophilic colloids is mixed with at least one iodopropargyl compound and at least one further biocidal active from the series consisting of fungicides, bactericides, herbicides, insecticides, and algicides, and
b) by adding coacervating aids and/or by changing the ambient conditions of the reaction mixture, the hydrophilic colloids are precipitated or deposited on the particle surface of the iodopropargyl compounds and biocidal actives, and
c) if desired, the coacervate shells of the thus-prepared mixture of coacervated iodopropargyl compounds and biocidal actives are crosslinked.

17. A process for preparing a mixture as claimed in claim 15, characterized in that at least one biocidal active from the series consisting of fungicides, bactericides, herbicides, insecticides, and algicides in solid or liquid form or, where appropriate, as a suspension or emulsion is mixed with the iodopropargyl compounds already coacervated, in any desired order.

18. Industrial materials comprising at least one coacervated iodopropargyl compound as claimed in claim 11.
